(19) United States
(12) Patent Application Publication
(10) Pub. No.: US 2015/0045475 A1
(43) Pub. Date: Feb. 12, 2015

(54) PIGMENTS COATED IN AN ACID-RESISTANT MANNER

(71) Applicant: Ley & Co. Farbenwerke Wunsiedel KG, Marktredwitz-Brand (DE)

(72) Inventor: Michael Nürnberger, Marktredwitz-Brand (DE)

(21) Appl. No.: 14/377,783

(22) PCT Filed: Feb. 7, 2013
(86) PCT No.: PCT/EP2013/052432

§ 371 Date: Aug. 8, 2014

(30) Foreign Application Priority Data
Feb. 11, 2012 (DE) 10 2012 002 824.5

(51) Int. Cl. C08K 9/04; B29C 45/00; B29C 47/00

(52) U.S. Cl. CPC C08K 9/04; B29C 47/0004; B29C 45/0001; B29K 2027/06
USPC 523/200; 264/176.1; 264/328.18

(57) ABSTRACT

The invention relates to the use of pigments coated in an acid-resistant manner in PVC synthetic material. Acid-soluble pigments are provided with a coating of an organic compound that melts at a temperature of T>200° C., and as a result the otherwise acid-soluble pigments are still protected from HCl vapor even at PVC processing temperatures of between 180° C. and 200° C.

The invention relates to the use of particular pigments coated in an acid-resistant manner in PVC, as well as to a PVC synthetic material comprising pigments coated in an acid-resistant manner.

Iron oxide pigments are widely used as cost-effective red, yellow, brown and black pigments. In thermoplastic processing of the synthetic material PVC, the use of iron oxide pigments is, however, possible only to a limited extent, as gaseous hydrogen chloride (HCl vapor) generated under production conditions at temperatures of 180° C. to 200° C. reacts to iron chloride with the iron oxides. Iron chloride, in turn, catalyzes the further degradation of PVC. The result of this further degradation is the so-called formation of burns. Burns are burnt, brown-colored areas which partially appear on the thermoplastically deformed synthetic material part. In this respect, the iron oxides Fe₂O₃ (red), FeOOH (yellow), Fe₃O₄, but also Fe—Mn-mixed oxides (brown, black), Fe—Zn-mixed oxides (zinc ferrite, yellow) and ZnO (white) are unstable with regard to HCl vapor and thus acid-soluble.

So-called thermostabilizers and acid stabilizers which are added to raw PVC are also unable to completely prevent the PVC's degradation when pigments containing zinc, iron or manganese, which are unstable with regard to HCl vapor, are present.

Until now, iron oxide pigments with inorganic coatings based on aluminum hydroxide and silicon dioxide are obtained by precipitation from aqueous solution and subsequent drying and grinding. However, the coating is incomplete, so that a significant solubility with respect to HCl vapor of the pigment core remains despite the existing coating, and thus the formation of burns on the PVC can be observed in thermoplastic processing.

The following document is known from the state of the art:
Solid particles are described in patent publication DE 1 519 544, which are coated with pentaerythritol. The pentaerythritol acts as a surfactant and is applied from the aqueous solution to the solid particles by means of a so-called covering process. The method differs considerably from the exemplary method for producing the pigments coated in an acid-resistant manner described below. In addition, no information is provided with respect to the outer surface coverage by the pentaerythritol on the solid particles. Due to the fact that the use of the solid particles concerns an improved dispersion behavior, it is assumed that the surface coverage rate is much less than 85%.

In addition, there is a plurality of publications describing the coating of particles by means of the so-called fluidized bed process or the so-called drum coating method. In these methods, the coating substance is injected in a liquid or suspended form through nozzles, and thus contacts the particles to be coated in a fine-particle state. Only the solvent is vaporized, but not the coating substance. As it stands at the moment, the facilities cannot be operated at 220° C. to 260° C. In addition, these methods are only suitable for particles having a grain size of greater than 1 μm, as the separation of the particles in the fluidized bed reaches its limits and the particles agglomerate.

GB 896,067 A discloses titanium dioxide particles which are coated with a coating comprising pentaerythritol for improving their dispersibility.

DE 102 09 698 A1 discloses a method for producing coated, fine-particle inorganic solids, in which the surface of fine-particle, inorganic solid particles is covered with at least two different organic additives. One of the additives may, for example, be pentaerythritol.

DE 27 33 734 discloses a method for treating inorganic oxide pigments, in particular titanium dioxide particles.

GB 1 265 092 A discloses an inorganic pigment easy to disperse, the surface of which carries a non-ionic substance consisting of a polyol with at least three OH groups, which is etherified with at least a monofunctional alcohol. The pigment may, for example, be iron oxide. Pentaerythritol may be used as polyol starting material for producing the ether product.

JP S48 33255 B1 discloses an iron oxide pigment with high dispersibility. The pigment may, for example, be treated with pentaerythritol tetrabenzoate.

It is an object of the invention to solve the above-described burn problem. According to the invention, a solution of such type is provided in this regard that the pigments mentioned above may be used without harmful burn formation in the thermoplastic processing of PVC as well.

The above-mentioned problem is solved by the use of pigments coated in an acid-resistant manner in PVC indicated in claim 1. Further embodiments are described in claims 2 to 7 6. Claim 7 8 describes the combination of PVC and pigments coated in an acid-resistant manner; corresponding further embodiments are described in claims 9 8 to 13 12.

In this respect, the acid-soluble pigments may be vapor-deposited with a coating of organic compounds. In this respect, the melting point of the vapor-deposited organic compound is greater than 200° C. and, for example, greater than 240° C., so that the coating continues to adhere to the surface of the acid-soluble pigment particles also during the thermoplastic forming process of PVC. If the melting point of the organic compound were lower, there would be a risk that it would melt at the usual processing temperatures of PVC of 180° C. to 200° C. and would thus not be able to serve its intended purpose. The organic compounds melting at T>200° C. are pentaerythritol, dipentaerythritol or benzenetricarboxylic acid. Pentaerythritol is also known as 2,2-Bis(hydroxymethyl)1,3-propanediol and has a melting point of 262° C. Dipentaerythritol is known as 1,3-Propanediol, 2,2-oxybis(methylene)bis2-(hydroxymethyl) and has a melting point of approximately 218° C. Benzenetricarboxylic acid comprises 1,2,4-Benzenetricarboxylic acid with a melting point of 231° C. and 1,2,3-Benzenetricarboxylic acid as well as 1,3,5-Benzenetricarboxylic acid.

The coating may, however, also be applied to the acid-soluble pigments using an alternative method and may, for example, be melted onto the pigments.

Acid-soluble pigments represent the base pigments or starting materials or the respective core of the pigments coated in an acid-resistant manner, and are selected from the following pigments: iron oxides Fe₂O₃ (red), FeOOH (yellow), Fe₃O₄ (black), but also Fe—Mn-mixed oxides (brown, black), Fe—Zn-mixed oxides (zinc ferrite, yellow) and ZnO (white). The acid-soluble pigments have, for example, a mean particle size of less than 5 μm, for example of less than 1 μm. The acid-soluble pigments may, for their part, already comprise a coating or a different cover of the base pigment grain. The indicated pigments are called acid-soluble, as they generate a faster degeneration of the PVC in the kneader test (see example item 2) (as a result of a reaction with HCl vapor). The pigments coated in an acid-resistant manner, in contrast, are characterized by the fact that the surface of the acid-soluble pigments is protected against the attack of hot HCl vapor by the coating.

The organic compound melting at T>200° C. is, for example, vapor-deposited onto the surface of the acid-soluble pigments or is applied to the surface otherwise. Vapor deposition means the conversion of the organic compound melting at T>200° C. into the gaseous phase by vaporizing or sublimation and the subsequent condensation or re-sublimation on the outer surface of the acid-soluble pigments. A vacuum pressure intensive heating mixer or a mechano-fusion mill may serve as reactors for the coating process. The reactor is operated, for example, under vacuum pressure of less than 40 mbar.

Vaporization of the organic compound melting at T>200° C. may also take place in an incomplete way, so that the coating is not 100% vapor-deposited, but is also in part melted onto the surface of the acid-soluble pigments. Sublimation may also take place in an incomplete way, so that remainders of un-sublimated coating starting material remain besides the pigments coated in an acid-resistant manner.

The surface coverage rate of the coating on the outer surface of the acid-soluble pigments is on average, for example, greater than 85%. The mass ratio of the organic compound melting at T>200° C., for example pentaerythritol, related to the acid-soluble pigment (starting material) is preferably 0.07 to 0.20, for example 0.08 to 0.12.

The vapor pressure of pentaerythritol is 1,013 mbar at T=355° C., and 40 mbar at T=276° C. In case of an even lower ambient pressure, such as less than 10 mbar, pentaerythritol can sublimate at a temperature of T<260° C. As already mentioned, the melting point of pentaerythritol is at 262° C. This reduction in temperature is of particular importance to the yellow iron oxide pigments (FeOOH), as they show discolorations on the pigment from 260° C.

The inventive area of application of the pigments coated in an acid-resistant manner extends to/covers the synthetic material PVC. The thermoplastic processing comprises, for example, extrusion and injection molding processes, but also casting, calendering and blow molding processes.

The pigments coated in an acid-resistant manner may be mixed/added alone or in combination with conventional organic or inorganic pigments, colorants and fillers, as well as various synthetic material stabilizers or solvents. In this respect, there is no limitation to a particular mixing ratio. In the case of PVC synthetic material, synthetic material stabilizers are understood as being the additives necessary for the thermoplastic shaping, such as thermostabilizers, softeners/plasticizers, acid scavengers, lubricants and antioxidant agents, whereas fillers refer to calcspar, heavy spar, talcum or kaolin. The polycyclic pigments, such as copper phthalocyanines, quinacridones, pyrrol pyrrols, isoindolines, perylenes, and the azo pigments, such as diaryl yellow and benzimidazolones, are typical representatives of organic pigments. The most important representatives of inorganic pigments are TiO₂, soot, ultramarines, rutile mixed phase pigments, chromium oxide green as well as a wide range of mixed oxide pigments. Representatives of colorants/dyes are, for example, anthraquinones, methines, perinones and anthrapyridones.

In this respect, the pigments coated in an acid-resistant manner may be incorporated into the target area of application directly as a powder component or mixed with other materials or as a concentrate in the form of a so-called master batch. A master batch is a premix or (color) concentrate, substantially consisting of 40 wt % to 90 wt % of a pigment or a filler of a pigment mixture, and 60 wt % to 10 wt % of a synthetic material mixture and/or a wax mixture.

The application concentration of the pigments coated in an acid-resistant manner in the inventive areas of application is greater than 0.01 wt % and less than 90 wt %, for example between 0.05 wt % and 20 wt %, and, for example between 0.1 wt % and 10 wt %.

### EXAMPLE

1. Method for producing the pigments coated in an acid-resistant manner The reaction mixture no. 1, consisting of 5 kg Bayferrox 120 (uncoated Fe₂O₃) and 0.5 kg pentaerythritol powder, is introduced into a vacuum pressure intensive heating mixer (self-construction). The reaction mixture no. 1 is heated at a pressure of 1 mbar with intensive mixing to 250° C. After a reaction time of 15 minutes, it is ventilated and cooled down. The sample taken out is the pigment coated in an acid-resistant manner no. 1.

The same method is carried out for the following pigments coated in an acid-resistant manner:
reaction mixture no. 2, consisting of 2 kg Bayferrox 420 (uncoated FeOOH) and 0.2 kg pentaerythritol, yields the pigment coated in an acid-resistant manner no. 2;
reaction mixture no. 3, consisting of 2 kg Bayferrox 3950 (uncoated zinc ferrite with the composition ZnFe₂O₄) and 0.2 kg pentaerythritol, yields the pigment coated in an acid-resistant manner no. 3;
reaction mixture no. 4, consisting of 2 kg zinc oxide white seal (uncoated ZnO) and 0.2 kg pentaerythritol, yields the pigment coated in an acid-resistant manner no. 4.

2. Examination as to HCl Vapor Resistance: Kneader Test
Respectively 0.2 wt % of the respective pigments were mixed to the thermostabilized PVC mixtures, and the mixture was subsequently subjected to thermal and mechanical stress using a kneader (company: Brabender). The PVC mixtures were kneaded in the kneader at 190° C. and 20 rpm. The aim is to generate HCl vapor through the thermal degradation of the PVC. The torque was determined as a function of time. The PVC's degradation is expressed by the torque curve. In case of a complete destruction of the PVC, a characteristically steep rise of the torque occurs. Following the characteristic rise, the PVC mixture loses its plastic properties and the test material swells out of the kneader. The degradation process of the PVC is optically characterized by a brown or black coloring. The pigments coated according to the invention are compared to uncoated samples as well as to conventionally coated samples according to Table 1.

Table 1 shows, as an example, only the behavior of a CA/Zn stabilized PVC mixture, as other thermostabilizer systems showed a similar behavior. In addition, a sample no. 0 with no pigment (pigment no. 0) and a sample no. 12 with 0.05% iron(III)chloride were used.

TABLE 1
Decomposition kinetics of PVC as a function of pigment addition

| | | | | | | Time (min.) |
|---|---|---|---|---|---|---|
| | | | | Time (min.) | Torque | until exit |
| | | Chemical | | until torque | maximum | from test |
| No. | Pigment | compound | Coating | maximum | (Nm) | space |
| 0 | without | — | — | 19 | 29 | no escape |
| 1 | Bayferrox 120-P | Fe₂O₃ | according to | 18 | 31 | no escape |
| | | | the invention | | | |
| 2 | Bayferrox 420-P | FeOOH | according to | 18 | 32 | no escape |
| | | | the invention | | | |
| 3 | Bayferrox 3950-P | ZnFe₂O₄ | according to | 18 | 30 | no escape |
| | | | the invention | | | |
| 4 | ZnO—P | ZnO | according to | 15 | 29 | no escape |
| | | | the invention | | | |
| 5 | Bayferrox 120 | Fe₂O₃ | without | 17 | 50 | 19 |
| 6 | Bayferrox 420 | FeOOH | without | 17 | 49 | 19 |
| 7 | Bayferrox 3950 | ZnFe₂O₄ | without | 17 | 47 | 19 |
| 8 | White seal | ZnO | without | 13 | 58 | 14 |
| 9 | Bayferrox 120-C | Fe₂O₃ | conventional | 17 | 50 | 19 |
| 10 | Colortherm 10 | FeOOH | conventional | 17 | 50 | 19 |
| 11 | Colortherm 30 | ZnFe²O⁴ | conventional | 17 | 48 | 19 |
| 12 | Fe³⁺ | FeCl₃ | — | 16 | 51 | 17 |

The measured values show that the pigments coated in an acid-resistant manner have a lower torque maximum than the conventionally coated pigments or than the uncoated pigments. The mixtures of PVC pigments coated in an acid-resistant manner behave almost identically with the 0-sample, especially with respect to the swelling-out of the samples from the test space during the kneading process.

The samples with FeCl₃ have a behavior that is similar to that of the samples with iron oxide pigments. This additionally suggests that iron ions catalyze the degradation of the PVC. The same applies in principle to zinc ions. They catalyze the degradation of PVC as well.

When compared to pigments coated in a conventional way, the pigments coated in an acid-resistant manner comprise a significantly higher HCl resistance in the thermoplastic shaping process of PVC.

The values measured at the kneader may also be transferred to practice. When using pigments coated in an acid-resistant manner containing iron, manganese and/or zinc, a reduced formation of burns can be observed in the PVC extrusion or PVC injection molding process.

The invention consequently refers to the use of pigments coated in an acid-resistant manner in the synthetic material PVC. Acid-soluble pigments are provided with a coating of an organic compound which melts at a temperature of T>200° C., in order to protect the otherwise acid-soluble pigments against HCl vapor also in case of processing temperatures of the PVC of 180° C. to 200° C.

1. A method of manufacturing a synthetic material, comprising:
providing a PVC synthetic material; and
adding to the PVC synthetic material pigments which are selected from the group of acid-soluble pigments consisting of Fe₂O₃, FeOOH, Fe₃O₄, iron manganese mixed oxides, ZnO, zinc ferrites and a combination of two or more of these pigments, and are coated with pentaerythritol and/or dipentaerythritol and/or benzenetricarboxylic acid as an organic compound melting at T>200° C. so as to be acid-resistant.

2. The method according to claim 1, further comprising:
subjecting the synthetic material to a thermoplastic processing,
wherein pigments coated so as to be acid-resistant avoid the formation of burns on the thermoplastically deformed synthetic material and/or wherein the coating protects the otherwise acid-soluble pigments during the thermoplastic processing against a reaction with HCl vapor produced during the thermoplastic processing.

3. The method according to claim 1, wherein more than 0.01 wt % and less than 90 wt % of pigments coated in an acid-resistant manner are used.

4. The method according to claim 1, wherein more than 85% of the outer surface of the acid-soluble pigments are covered by the organic compound melting at T>200° C.

5. The method according to claim 1, wherein the organic compound melting at T>200° C. is vapor-deposited onto the acid-soluble pigments.

6. The method according to claim 1, wherein the mass ratio of the organic compound melting at T>200° C. to the acid-soluble pigments is in a range of 0.07 to 0.2.

7. The method according to claim 1, wherein the acid-soluble particles have an average particle size of less than 5 μm.

8. A PVC synthetic material comprising pigments coated in an acid-resistant manner, wherein the pigments coated in an acid-resistant manner comprise acid-soluble pigments selected from the group consisting of Fe₂O₃, FeOOH, Fe₃O₄, iron manganese mixed oxides, ZnO, zinc ferrites and a combination of two or more of these pigments, which are coated with pentaerythritol and/or dipentaerythritol and/or benzenetricarboxylic acid as an organic compound melting at T>200° C., so as to be acid-resistant.

9. The PVC synthetic material according to claim 8, wherein more than 0.01 wt % and less than 90 wt % pigments coated in an acid-resistant manner are used.

10. The PVC synthetic material according to claim 8, wherein more than 85% of the outer surface of the acid-soluble pigments are covered by the organic compound melting at T>200° C.

11. The PVC synthetic material according to claim 8, wherein the organic compound melting at T>200° C. is vapor-deposited onto the acid-soluble pigments.

12. The PVC synthetic material according to claim 8, wherein the acid-soluble particles have an average particle size of less than 5 μm.

13. The PVC synthetic material according to claim 8, wherein the mass ratio of the organic compound melting at T>200° C. to the acid-soluble pigments is in a range of 0.07 to 0.02.

14. The method according to claim 3, wherein more than 0.05 wt % and less than 20 wt % of pigments coated in an acid-resistant manner are used.

15. The method according to claim 3, wherein more than 0.1 wt % and less than 10 wt % of pigments coated in an acid-resistant manner are used.

16. The method according to claim 2, wherein more than 0.01 wt % and less than 90 wt % of pigments coated in an acid-resistant manner are used.

17. The method according to claim 16, wherein more than 0.05 wt % and less than 20 wt % of pigments coated in an acid-resistant manner are used.

18. The method according to claim 16, wherein more than 0.1 wt % and less than 10 wt % of pigments coated in an acid-resistant manner are used.

19. The method according to claim 6, wherein the organic compound melting at T>200° C. is pentaerythritol.

20. The method according to claim 6, wherein the mass ratio of the organic compound melting at T>200° C. to the acid-soluble pigments is in a range of 0.08 to 0.12.

21. The method according to claim 7, wherein the acid-soluble particles have an average particle size of less than 1 μm.

22. The PVC synthetic material according to claim 9, wherein more than 0.05 wt % and less than 20 wt % pigments coated in an acid-resistant manner are used.

23. The PVC synthetic material according to claim 9, wherein more than 0.1 wt % and less than 10 wt % pigments coated in an acid-resistant manner are used.

24. The PVC synthetic material according to claim 12, wherein the acid-soluble particles have an average particle size of less than 1 μm.

25. The PVC synthetic material according to claim 13, wherein the organic compound melting at T>200° C. is pentaerythritol.

26. The PVC synthetic material according to claim 13, wherein the mass ratio of the organic compound melting at T>200° C. to the acid-soluble pigments is in a range of 0.08 to 0.12.

27. The PVC synthetic material according to claim 9, wherein more than 85% of the outer surface of the acid-soluble pigments are covered by the organic compound melting at T>200° C.

28. A method of manufacturing a synthetic material, comprising:
providing a PVC synthetic material; and
adding to the PVC synthetic material pigments;
wherein the pigments are selected from the group of acid-soluble pigments consisting of Fe₂O₃, FeOOH, Fe₃O₄, iron manganese mixed oxides, ZnO, zinc ferrites and a combination of two or more of these pigments; and
wherein the pigments are coated with pentaerythritol and/or dipentaerythritol and/or benzenetricarboxylic acid as an organic compound melting at T>200° C. so as to be acid-resistant,
so that a formation of burns as a result of thermoplastically deforming the PVC synthetic material is avoided and/or the acid-soluble pigments are protected during a thermoplastic processing of the PVC synthetic material against a reaction with HCl vapor produced during the thermoplastic processing of the PVC synthetic material.
